(19) United States
(12) Patent Application Publication
(10) Pub. No.: US 2009/0317599 A1
(43) Pub. Date: Dec. 24, 2009

(54) Multiple level layered floating effect canvas panel array

(75) Inventor: Victoria E. Heuman, Seattle, WA (US)

Correspondence Address: Victoria E. Heuman, 2764 45th Ave. SW, Seattle, WA, 98116, US

(73) Assignee: Victoria E. Heuman, Seattle, WA (US)

(21) Appl. No.: 12/456,871

(22) Filed: Jun. 22, 2009

Related U.S. Application Data
(60) Provisional application No. 61/075,192, filed on Jun. 24, 2008.

(51) Int. Cl. B32B 3/02

(52) U.S. Cl. 428/189

(57) ABSTRACT

A 3-dementional array of multiple artist canvas panels configured in a plurality of levels. The artist canvas panels are rigidly interconnected by Z-brackets with screws from the wooden portions, layered, overlapped and gapped to create a self supportive embodiment to be hung on a wall.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

Field of the Invention

This invention relates to the evolution of canvas art. Specifically, to the improvements in displaying an array of pre-stretched artist canvas panels by means of interconnecting them so as to create a multiple level, 3-dimensional, floating canvas panel effect.

The present invention was conceived in June of 2008 whereas a Provisional Patent was applied for re: Application No. 61/075,192 dated Jun. 24, 2008.

For centuries and through the years, artist, curators, and designers have sought and implemented many methods of presenting art. In the field of fine art, canvas has proven itself to be the most reliable support medium for oil and acrylic paintings. After the influence of the modern art movement, many artists have broken away from the practice of creating singular canvas art. The most current contemporary application has been to split a painting into multiple, stand alone canvases to be displayed together, in a singular plane, as one work of art. The present invention although seemingly simple, but with some important and necessary guidelines improves on the contemporary use of multiple canvases by configuring them into multiple, overlapping planes as to create a 3-dimensional floating effect without compromising the integrity of the art it supports.

Patents teaching of attaching canvas panels in a 3-dementional configurations are virtually non-existent, the following patents are, however, the presentation of prior art.

U.S. Pat. No. 5,027,537, Freeman teaches of a method in which to display circular plastic emblems above a license plate using Z-brackets affixed to the back of the license plate to the back of the plastic emblem. Although Freeman shows us a way to incorporate “Z bracketry” in order to attach one relatively flat object to another creating an interconnected display of two sign objects, Freeman does not teach how to make two interconnected sign objects to appear to float as the Z-brackets in is invention are apparent from plain view. The present invention has improved this with inconspicuous Z-bracket application compelling the viewer to ponder the means in which multi canvases appear to be floating.

U.S. Pat. No. 6,338,215 issued to Vincent teaches of a 3-dementional configuration of picture frames. The frames are made of wood or metal, and although Vincent does teach of a method in which one can attach picture frames in multiple planes, such method would not work for our invention as it requires the boring of holes from the back of the first forward frame to the font of the rearward frame. This is a wonderful method for something of the likes of picture frames. Frames are only assemblies in which you place art/photographs. In the field of fine arts, boring holes through artist canvas would be considered unacceptable practice. Damaging the delicate woven support medium of an original art piece would diminishing the ultimate value and collectability of the piece, rendering it nearly worthless. Therefore, cylinder spacers would not work in the present invention.

The above mentioned patents, although valuable in their own genre, do not lend any merit in the fastidious industry of fine art, therefore does not overcome difficulties in the present invention.

### OBJECT AND SUMMARY OF THE INVENTION

The object of the invention provides a 3-dimensional array of canvas panels and overcomes difficulties described previously with the tactful use of Z-brackets extending between canvas panels creating multiple planes.

It is further an object of the invention to securely fasten artist panels with Z-brackets to construct rigid attachments creating a visually appealing, yet lasting art piece for collectable value.

It is further an object of the invention to create a 3-dementional floating appearance all while maintaining the integrity of the valuable canvas surfaces.

It is further an object to the invention to create a self supportive embodiment with interconnections of canvas panels and Z-brackets so to be hung on a wall as one work of art.

It is further an object of the invention that the overlapping of canvas panels fashions the array in such a way as to make the Z-bracket inconspicuous at a minimum 45 degree angle or less.

It is further an object of the invention that the Z-brackets, through their set size, shape, and strength, easily maintain correct alignment and spacing/gapping.

It is further an object of the invention that the Z-brackets easily allow for many 3-dementional configurations.

It is lastly an object of the invention that the different sizes of artist canvas panels allow for many 3-dementional configurations.

### BRIEF DESCRIPTION OF THE SEVERAL VIEWS OF THE DRAWING

The present invention, other features, and advantages will be better understood and become apparent when reading the detailed description of the preferred embodiment, and when taken together with the drawing wherein;

FIG. 1 is a perspective view illustrating a preferred embodiment of the present invention.

FIG. 2 is a front view of the preferred embodiment.

FIG. 3 is a rear view of the preferred embodiment.

FIG. 4 is an end view as viewed from the left end of the preferred embodiment.

FIG. 5 is an enlarged cross sectional view from the left, showing typical aspects of Z-brackets, overlapping of canvas, and gapping from plane to plane.

FIG. 6 is a perspective view of a Z-bracket (typical) used in the preferred embodiment.

FIG. 7 is an enlarged, transparent perspective view of the upper right hand corner of FIG. 1, of the preferred embodiment.

FIG. 8 is a perspective view of an alternative configuration of the preferred embodiment.

### DETAILED DESCRIPTION OF PREFERRED EMBODIMENT

This detailed description of the preferred embodiment is to be read with the accompanied drawings which are part of the entire written description of this invention.

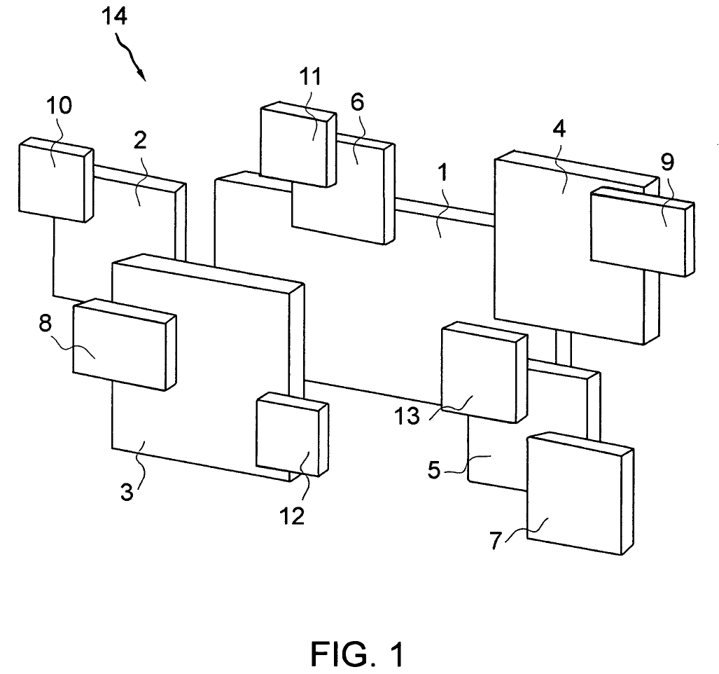

In the preferred embodiment, FIG. 1, shows an array 14 of artist canvas panels (canvases). Thirteen canvases 1-13 are included in the embodiment, although any number of canvases can be chosen (aesthetically permitting.)

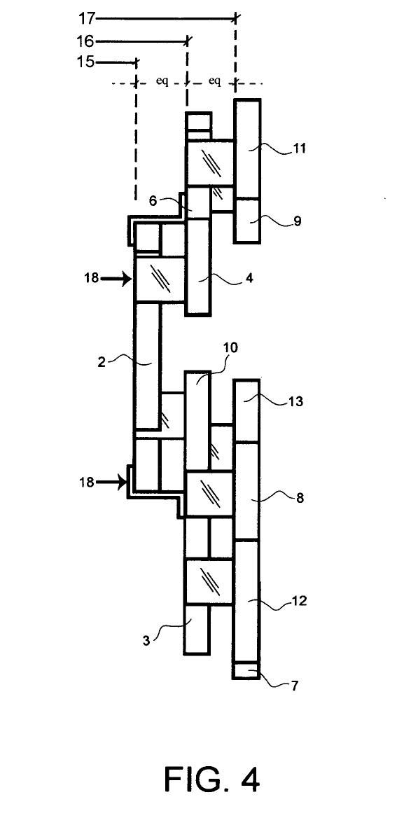

In the preferred embodiment, artist canvas panels 1-13 are arranged in three paralleling, planar planes FIG. 4, a first rearward plane 15 containing canvases 1 and 2, a secondary plane 16 containing artist canvas panels 3-6, and a third forward plane 17 containing canvases 7-13. It is possible to arrange artist panels 1-13 in 4 or more levels. (not shown)

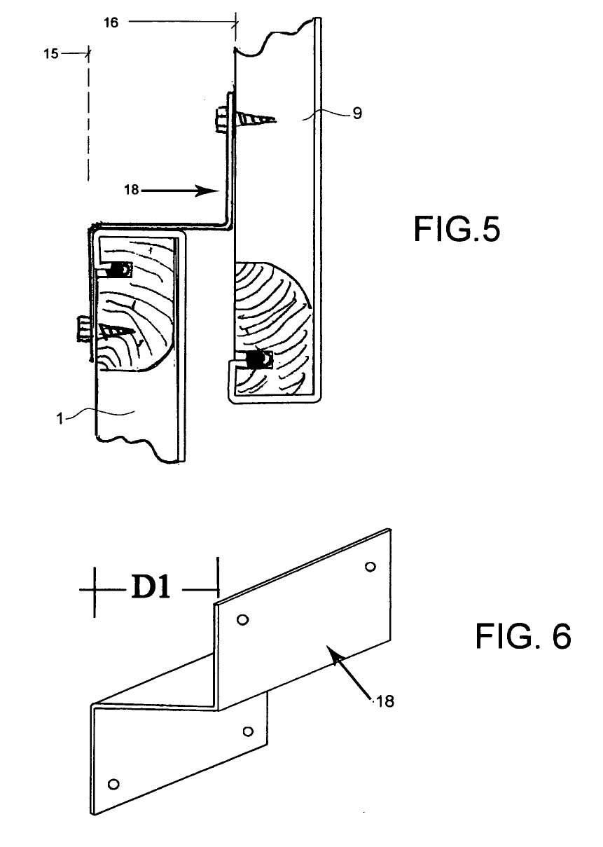

In the preferred embodiment, canvases as viewed from the rear elevation FIG. 3, depict the rear plane 15 is connected to the secondary plane 16 and the third forward plane 17 is connected to the secondary plane 16 by Z-brackets 18 depicted in FIG. 4, FIG. 5, and FIG. 6. The protrusion of the canvases are ahead of and overlapping canvases 1 and 2 and furthermore, canvases 7-13 protrude ahead of and overlap canvases 3-6 creating a 3-dementional floating effect when the array 14 is supported/hung on a wall (not shown) by a hanger (not shown or specified).

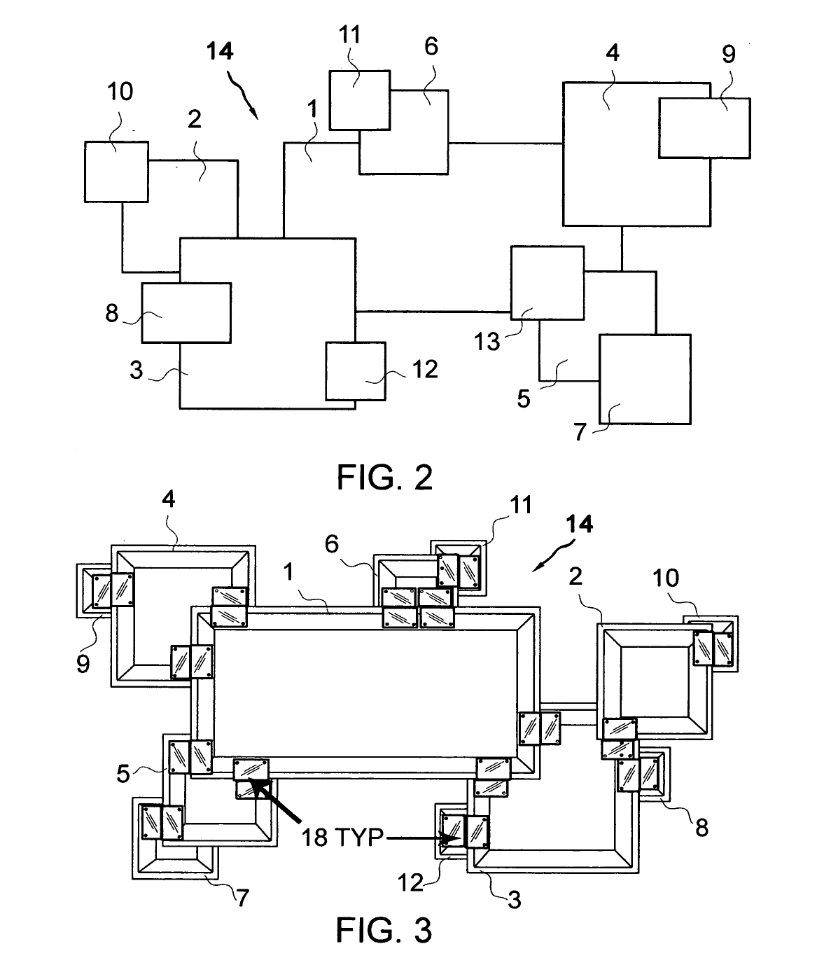

FIG. 2 is a front elevation showing artist canvas panels 1-13 so as to aid in clarifying the overlapping of canvas panels to their relative canvas panels.

FIG. 3 is an elevation of the array 14 clarifying and supporting prior statements of planar planes interconnecting the rearward plane 15 to their secondary plane 16 and the third forward plane 17 back to the secondary plane 16, whereas it also clarifies overlapping as viewed from said elevation.

FIG. 4 is a left elevation of the array 14 illustrating and clarifying prior statements of protrusions of the planar planes 16 and 17 and the perspective orientation of Z-brackets 18 connecting planes 15-17.

FIG. 5 is a cross-section where artist panel 1 is connected to artist panel 6 depicting the dimensional proportional relationship of an artist canvas panel to a plane protrusion, whereas a canvas panel consumes 58% of a given plane and a space/gap consumes 42% of a given plane, and clarifies screw attachment to the respective rears of the artist canvas panels, [typical] through Z-brackets 18.

FIG. 6 is a perspective view drawing of a Z-bracket 18 whereas, the Z-bracket 18 is sheet metal, who's offset leg D1 is equal to a plane protrusion, who's length is 50% longer than its offset leg, and who's opposing tangs are equal to its offset leg having two screw holes per tang.

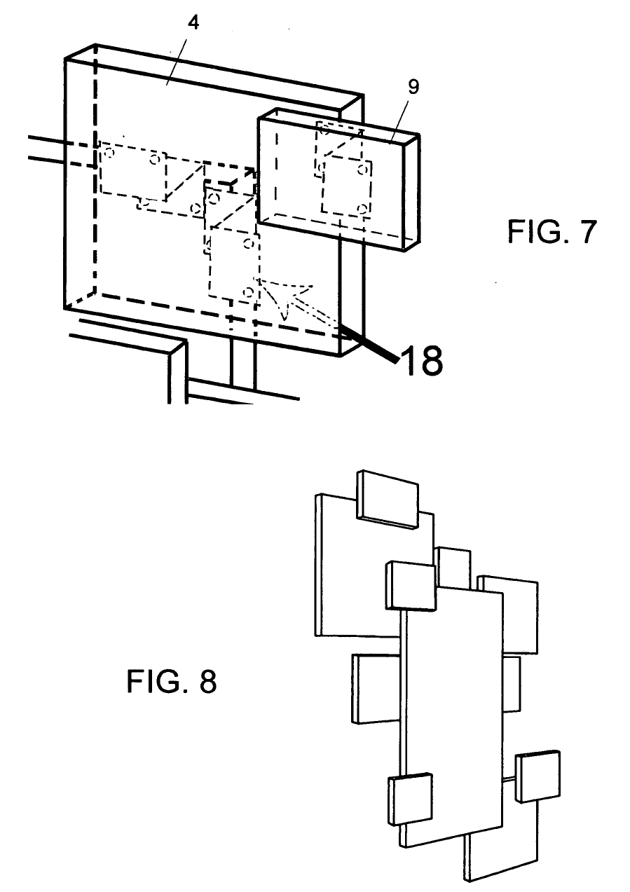

FIG. 7 is a perspective view of artist panel 4 and 9 showing typical placement of Z-brackets 18.

FIG. 8 is a perspective view of an alternate array of artist canvas panels, whereas eleven canvases are present, (in said figure,) in lieu of thirteen as shown in FIG. 1.

I claim as my invention:

1. A self supportive array of interconnected canvas panels, comprising:
a plurality of canvas panels in a first plane, a second set of canvas panels located in a second plane, partially overlapping, parallel to, gapped a set distance, and interconnected to the first plane, and a third set of canvas panels located in a third plane, partially overlapping, parallel to, gapped a set distance, and interconnected to the second plane; and,
a first set of said Z-brackets connected to the rear of the canvas panels in said first plane extending and connecting forward to the rear of the canvas panels of said second plane, and a second set of said Z-brackets connected from the rear of the canvas panels in the second plane extending forward connecting to the rear of the canvas panels of said third plane.

2. The self supportive array of interconnected canvas panels according to claim 1 are fastened to said Z-brackets protrude from said plane to plane by bi-passing the canvas of said canvas panels, and the canvas is uninterrupted.

3. The self supportive array of interconnected canvas panels according to claim 1 are gapped from each relative plane by the set length of the said offset leg of said Z-bracket which offset leg is greater than the depth of the said rearward canvas panel.

4. The self supportive array of interconnected canvas panels according to claim 1, wherein the minimum overlap of a forward said canvas panel to the rearward said canvas panel is equal or greater than the said set gap distance.

5. The self supportive array of interconnected canvas panels according to claim 1 are constructed so as to be a singular embodiment.

6. The self supportive array of interconnected canvas panels according to claim 1, wherein the said canvas panels comprise of canvas covering the front and sides of wooden stretcher boards.

7. The self supportive array of interconnected canvas panels according to claim 2, wherein said Z-brackets are fastened to the wood of the artist canvas panel with screws trough the paired holes per said opposing tangs.

8. The self supportive array of interconnected canvas panels according to claim 1 are configured to be parallel and planar in relationship to all respective said canvas panels.
